(19) United States
(12) Patent Application Publication
(10) Pub. No.: US 2026/0140007 A1
(43) Pub. Date: May 21, 2026

(54) METHOD FOR CHECKING THE TIGHTNESS OF AN ELEMENT SUCH AS A FLUID MACHINE OR A VALVE

(71) Applicant: L'Air Liquide, Societe Anonyme pour l'Etude et l’Exploitation des Procedes Georges Claude, Paris (FR)

(72) Inventors: Thibaut FRANCOIS, Paris (FR); Marvin BENZAQUI, Paris (FR); Camille BLIN-OUDARD, Paris (FR)

(21) Appl. No.: 19/393,503

(22) Filed: Nov. 18, 2025

(30) Foreign Application Priority Data
Nov. 19, 2024 (FR) FR2412599

(51) Int. Cl. G01M 3/28

(52) U.S. Cl. CPC G01M 3/2876

(57) ABSTRACT

Method for checking the tightness of an element, such as a fluid machine or valve, arranged on a fluid transfer line between a fluid source and at least one storage tank, the element to be checked including a set of seal(s), the method comprising the following successive steps: a step of filling the storage tank from the source via the element to be checked, a step of stopping the filling of the storage tank, a step of monitoring a trend curve of the pressure of the fluid at the outlet of the element to be checked, and a step of determining the tightness of the element to be checked using the trend curve of the pressure at the outlet of the element to be checked.

### CROSS REFERENCE TO RELATED APPLICATIONS

This application claims the benefit of priority under 35 U.S.C. § 119 (a) and (b) to French patent application No. FR2412599, filed Nov. 19, 2024, which is herein incorporated by reference in its entirety.

### FIELD OF THE INVENTION

The invention relates to a method for checking the tightness of an element such as a fluid machine or a valve, arranged on a fluid transfer line. More specifically, the element to be checked is arranged between a fluid source and a storage tank. The fluid concerned may be liquid or gaseous hydrogen. When the element to be checked is a fluid machine, it may be a pump or a compressor.

### BACKGROUND OF THE INVENTION

To check the tightness of an element arranged on a transfer line between a fluid source and a storage tank, in situ monitoring, i.e. monitoring at the element to be checked itself, is generally difficult to implement.

As an alternative, there is a checking method that involves using a flow meter to determine a mean flow rate at the outlet of the element to be checked. The mean flow rate is obtained by means of a flow meter downstream of the element to be checked, which measures the flow rate when the transfer is stopped, after a filling phase of the storage tank.

According to this checking method, if the flow meter downstream of the element to be checked provides a flow rate value above a given threshold, this indicates the appearance of leaks, and therefore a loss of tightness of the element in question.

However, existing flow meters can only detect a variation in flow rate within a limited variation range (between 20% and 30%), thereby preventing leaks from being detected when the variation in flow rate is outside this range.

In other words, existing flow meters have a relatively narrow operating range, and therefore wear and loss of tightness of the element to be checked will have already reached an advanced stage by the time these flow meters provide a flow rate value at the outlet of the element to be checked, which will then require an emergency maintenance operation on the element to be checked.

Moreover, while the results provided by existing flow meters are generally accurate, they may fluctuate depending on the operating conditions of the element to be checked.

### SUMMARY OF THE INVENTION

An objective of the invention is to overcome the drawbacks listed above, and to develop a checking method which is simple to implement and which can also be used to determine the remaining service life of the element to be checked.

To this end, the invention proposes a method for checking the tightness of an element such as a fluid machine or a valve, arranged on a fluid transfer line between a fluid source and at least one storage tank. The element to be checked includes a set of seal(s).

The method comprises the following successive steps: a step of filling the storage tank from the source via the element to be checked, a step of stopping the filling of the storage tank, a step of monitoring a trend curve of the pressure of the fluid at the outlet of the element to be checked, and a step of determining the tightness of the element to be checked using the trend curve of the pressure at the outlet of the element to be checked.

Embodiments of the invention according to any of the aspects set out above may include one or more of the following features:
if the trend curve is monotonic, the step of determining the tightness indicates a first state of the seals of the element to be checked, and a leakage level below a predefined threshold, and, if the trend curve is variable, the step of determining the tightness indicates a second state of the seals of the element to be checked, and a leakage level greater than the predefined threshold,
the trend curve comprises a first decreasing phase in which the pressure at the outlet of the element to be checked decreases relatively slowly, a second decreasing phase in which the pressure at the outlet of the element to be checked decreases more rapidly, and a third monotonous phase in which the pressure at the outlet of the element to be checked is equal to an inlet pressure of the storage tank,
the step of determining the tightness of the element to be checked determines a leakage flow rate of each phase of the trend curve using a slope associated with said phase,
the step of determining the tightness of the element to be checked determines an inflection point on the trend curve referred to as the leakage pressure, marking the transition from the first decreasing phase to the second decreasing phase,
the method comprises a step of determining the remaining service life of the seals of the element to be checked on the basis of a predefined performance indicator as a function of the distribution of the trend curve,
the performance indicator is chosen from: the duration of the first decreasing phase of the trend curve, the leakage flow rate associated with the first decreasing phase of the trend curve, the value of the leakage pressure marking the transition from the first decreasing phase to the second decreasing phase,
the method comprising a step of generating, on the basis of a value of the performance indicator, a signal that can be used in a maintenance operation for the element to be checked,
the trend curve is a function of the ambient temperature and/or the temperature of a coolant fluid of the element to be checked, and/or the material of the seals of the element to be checked and/or the geometry of the seals of the element to be checked,
the element to be checked is a fluid machine, such as a compressor or a pump,
the fluid machine comprises a liner, a piston movable within the liner, the seal or seals being arranged in one or more respective grooves provided in a side wall of the piston facing a side wall of the liner,
the element to be checked is a valve.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments. Further specific features and advantages will become apparent upon reading the description below, which is provided with reference to the following figures, in which:

FIG. 1 is a schematic view illustrating a filling station comprising a transfer line connecting a fluid source, a fluid machine and at least one storage tank.

FIG. 2 is a schematic sectional view partially illustrating the fluid machine in FIG. 1, the fluid machine comprising a piston, a liner and at least one seal between the liner and the piston, the seal being pressed against the liner.

FIG. 3 is a schematic sectional view partially illustrating the fluid machine in FIG. 2 with the seal shown in a contracted configuration, forming with the liner a leak path of limited flow area.

FIG. 4 is a schematic sectional view partially illustrating the fluid machine in FIG. 2 with the seal shown in a contracted and worn configuration, forming with the liner a leak path of greater flow area.

FIG. 5 illustrates the steps of the method for checking the tightness of a fluid machine illustrated in FIG. 1.

FIG. 6 illustrates a series of trend curves of the pressure of the fluid at the outlet of the fluid machine when stopped, each curve comprising a first decreasing phase, a second decreasing phase, a stabilization phase, and a point of inflection (leakage pressure) marking the transition from the first decreasing phase to the second decreasing phase.

FIG. 7 illustrates the trend of the leakage flow rate and of the leakage pressure over the life cycle of a fluid machine in FIG. 1.

### DETAILED DESCRIPTION OF THE INVENTION

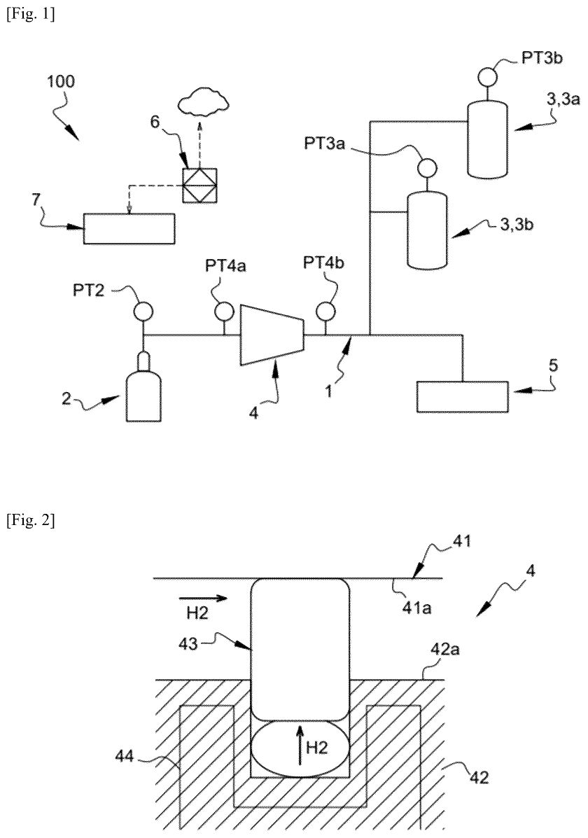

FIG. 1 illustrates a station 100 for dispensing a fluid comprising a transfer line 1 which connects a fluid source 2 and at least one storage tank 3. Between the fluid source 2 and the storage tank 3, the transfer line 1 comprises an intermediate element 4, the tightness of which requires checking. The intermediate element 4 is also referred to hereinafter as the “element 4 to be checked”.

The intermediate element 4 may be a valve or a fluid machine. In the second case, it may be more specifically a pump or a compressor.

The transfer line 1 may also comprise at least one dispenser 5 intended to supply a vehicle tank. The dispenser 5 is arranged downstream of the element 4 to be checked, and in parallel with the storage tank 5 with respect to the element 4 to be checked.

In the example shown in FIG. 1, the transfer line 1 comprises two storage tanks: a high-pressure tank 3a and a low-pressure tank 3b. The two storage tanks 3a, 3b are parallel to each other with respect to the element 4 to be checked. In this case, the element 4 to be checked is a fluid machine, and more specifically a compressor.

Advantageously, the fluid source 2, the storage tank or tanks 3a, 3b, and the element 4 to be checked are each provided with at least one pressure sensor PT2, PT3a, PT3b, PT4a, PT4b. In the example shown, the element 4 to be checked is fitted with an upstream pressure sensor PT4a and a downstream pressure sensor PT4b.

The various pressure sensors PT2, PT3a, PT3b, PT4a, PT4b are configured to communicate with a controller 6 which can itself communicate with a control unit 7. The controller is preferably an electronic data acquisition and processing unit, for example comprising a microprocessor.

As indicated above, the element 4 to be checked may be a fluid machine, such as a compressor or a pump.

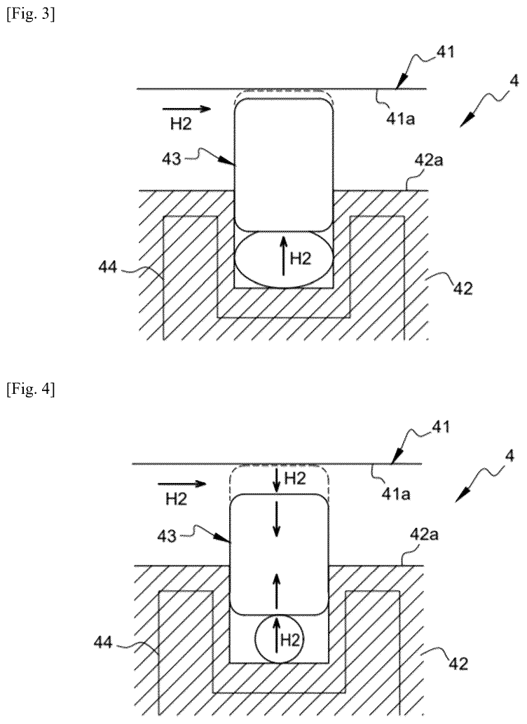

With reference to FIG. 2, FIG. 3 and FIG. 4, the fluid machine 4 comprises a liner 41, a piston 42 arranged inside the liner 41. The liner 41 and the piston 42 are configured to be in reciprocal motion relative to each other.

The fluid machine 4 also comprises a channel 44 configured to ensure a flow of a coolant fluid in the piston 42, and at least one seal 43 arranged between the piston 42 and the liner 41. The seal or seals 43 are arranged in one or more grooves provided in a side wall 42a of the piston 42.

In the example illustrated in FIG. 2, FIG. 3 and FIG. 4, a single seal 43 is shown. However, the description given in relation to this illustrated seal also applies to all of the seals that are not illustrated.

With reference to FIG. 2, the seal 43 is in tight contact with a side wall 41a of the liner 41. With the relative reciprocating motion between the piston 42 and the liner 41, the seal 43, otherwise secured to the piston 41, is subjected to friction against the side wall 41a of the liner 41. The repetition of this reciprocal motion leads to progressive wear of the seal 43 and to a loss of tightness in the fluid machine 4.

As shown in FIG. 3 and FIG. 4, the seal 43 is no longer tightly fitted to the side wall 41a of the liner 41. In this case, the seal 43 instead forms a lateral gap with the side wall 41a of the liner 41, referred to as a leak path.

The leak path illustrated in FIG. 3 has a relatively small flow area compared to the leak path illustrated in FIG. 4 where the seal 43 has undergone lateral contraction due to the temperature of the fluid, in addition to wear caused by friction against the side wall 41a of the liner 41. The lateral contraction of the seal 43 is represented by arrows in opposing directions.

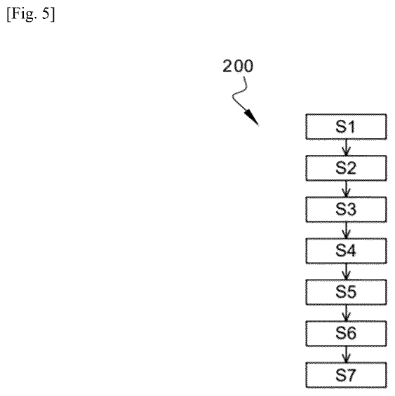

In order to check the leakage level resulting from wear, and possibly from the lateral contraction of the seal or seals 43, the invention provides a checking method 200, illustrated in FIG. 5. This method 200 also applies when the element 4 to be checked is a valve. In this case, the term “fluid machine” used below can be replaced by the term “valve”.

The method 200 comprises the following successive steps: a step S1 of filling the storage tank 3a, 3b from the fluid source 2 via the fluid machine 4, a step S2 of stopping the filling of the storage tank 3a, 3b, a step S3 of recording a trend curve C1-Cn of the pressure P of the fluid at the outlet of the fluid machine 4 (which has been stopped), and a step S4 of checking the tightness of the fluid machine 4 using the trend curve C1-Cn of the pressure P of the fluid at the outlet of the fluid machine 4.

Hereinafter, the trend curve C1-Cn of the pressure P of the fluid at the outlet of the fluid machine 4 will also be referred to simply as “the trend curve C1-Cn”.

The trend curve C1-Cn is recorded by the controller 6. The latter records, at a given acquisition frequency, for example every second, pressure values P provided by the pressure sensor PT4b positioned downstream of the fluid machine 4.

The trend curve C1-Cn can be monotonic or variable. A monotonic trend curve C1-Cn means that the seals 43 of the fluid machine 4 are in a nominal state (i.e. an unworn state), and that the leakage level remains below a predefined threshold. On the other hand, a variable trend curve C1-Cn indicates wear or incipient wear of the seals 43 of the fluid machine 4, with a leakage level greater than the predefined threshold.

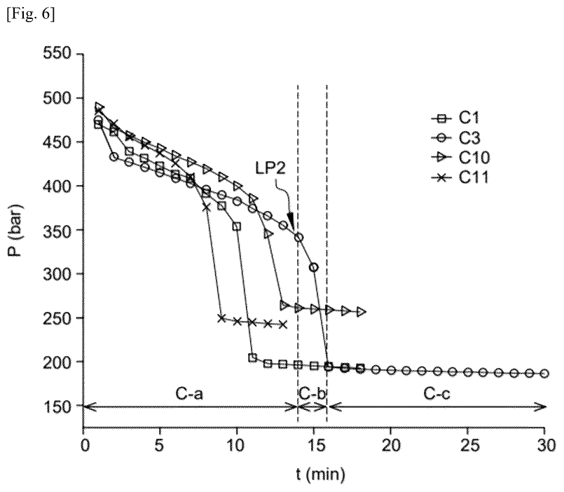

FIG. 6 illustrates a plurality of trend curves C1-Cn, obtained over one day's operation of the element 4 to be checked and for different degrees of wear of the seals 43. The curves C1 and C11 are respectively the first curve and the last curve of the day considered.

FIG. 6 also shows that each trend curve C1-Cn comprises a first decreasing phase C-a in which the pressure P at the outlet of the machine 4 decreases relatively slowly, a second decreasing phase C-b in which the pressure P at the outlet of the fluid machine 4 decreases more rapidly, and a third stable phase C-c in which the pressure P at the outlet of the fluid machine 4 is equal to the inlet pressure of the storage tank 3a, 3b.

It can also be seen that each trend curve C1-Cn has a point of inflection, referred to as the leakage pressure and denoted LP2, marking the transition from the first decreasing phase C-a to the second decreasing phase C-b. This point of inflection can be read directly from the trend curve C1-Cn, or obtained by calculation using a second derivative of the trend curve C1-Cn.

The trend curve C1-Cn can be used to determine, for example by calculation, a leakage flow rate LR at the outlet of said fluid machine 4, and notably a first fluid flow rate LR1 associated with the first decreasing phase, a second leakage flow rate associated with the second decreasing phase C-b, and a third leakage flow rate associated with the third phase C-c. The leakage flow rate LR for each phase C-a, C-b, C-c is determined from a slope of the curve C1-Cn at the phase C-a, C-b, C-c considered.

Advantageously, the method 200 also comprises a step S5 of determining a value of a performance indicator that can be used to estimate the remaining service life of the seals 43 of the fluid machine 4 from the shape of the trend curve. The performance indicator may be selected from at least one of the following parameters: the duration of the first decreasing phase C-a, the first leakage flow rate LR1 associated with the first decreasing phase C-a, and the leakage pressure LP2 marking the transition from the first decreasing phase C-a to the second decreasing phase C-b.

In order to determine the value of the performance indicator, the checking method 200 according to the invention uses the trend curve C1-Cn, as recorded by the controller 6 when the fluid machine 4 is stopped.

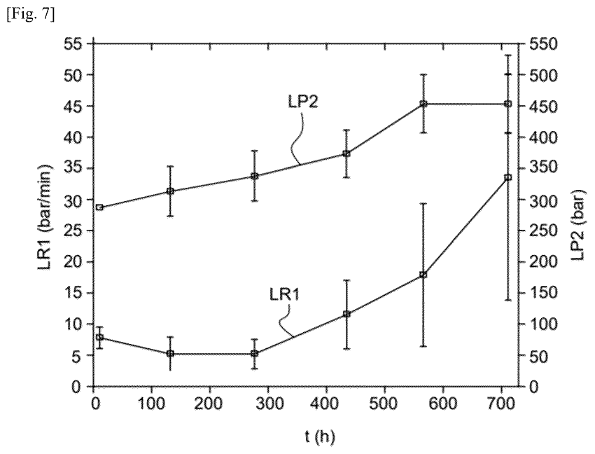

The method 200 can also use a first predetermined predictive curve LR1 giving the trend of the leakage flow rate during the life cycle of the fluid machine 4 and/or a second predetermined predictive curve LP2 giving the trend of the leakage pressure during the life cycle of the fluid machine 4. The curves LR1, LP2 are illustrated in FIG. 7.

The predetermined predictive curves LR1, LP2 can be obtained by plotting, on the same graph, data (mean leakage flow rate or leakage pressure) obtained from several trend curves C1-Cn recorded over several days, each giving the pressure trend at the outlet of the fluid machine 4. Recording the trend curves C1-Cn over several days makes it possible to monitor the trend of the wear of the seals 43.

The first predetermined predictive curve LR1 shows that the leakage flow rate decreases during the first tens of hours. This decreasing phase is due to the formation of a film between the seals 43 and the liner 41 of the fluid machine 4. After this decreasing phase, the static leakage flow rate increases, indicating progressive wear of the seals 43 as they are used.

The second predetermined predictive curve LP2 shows that the leakage pressure increases continuously during the life cycle of the seals 43, from about 300 bar to about 450 bar.

The checking method 200 provided by the invention thus makes it easier to evaluate the leakage level at an element 4 of the transfer line 1, and to determine the degree of wear of the seals 43 associated with this element 4.

It should be noted that the shape of the trend curve C1-Cn, the shape of the leakage flow rate LR1, the shape of the leakage pressure LP2, and the performance indicator may depend on the material and/or the geometry of the seals 43 of the element 4 to be checked, and/or the ambient temperature and/or the temperature of a coolant fluid of the element 4 to be checked.

Thus, the method 200 according to the invention enables the influence of the aforementioned parameters on the service life of the seals 43 of the element 4 to be checked to be precisely determined.

Advantageously, the checking method 200 according to the invention may comprise a step S6 in which the controller 6 or the control unit recommends a maintenance operation for the fluid machine 4, on the basis of a value of the performance indicator.

Thus, the method 200 according to the invention enables improved planning of preventive maintenance operations.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

We claim:

1. A method for checking the tightness of an element arranged on a fluid transfer line between a fluid source and at least one storage tank, the element to be checked including a set of seal(s), wherein the element is selected from the group consisting of such as a fluid machine, a valve, and combinations thereof, the method comprising the following successive steps:
filling the storage tank from the source via the element to be checked;
stopping the filling of the storage tank;
monitoring a trend curve of the pressure of the fluid at the outlet of the element to be checked; and
determining the tightness of the element to be checked using the trend curve of the pressure at the outlet of the element to be checked.

2. The method according to claim 1, wherein upon a determination that the trend curve is monotonic, the step of determining the tightness indicates a first state of the seals of the element to be checked, and a leakage level below a predefined threshold, and wherein, upon determining the trend curve is variable, the step of determining the tightness indicates a second state of the seals of the element to be checked, and a leakage level greater than the predefined threshold.

3. The method according to claim 1, wherein the trend curve comprises a first decreasing phase in which the pressure at the outlet of the element to be checked decreases relatively slowly, a second decreasing phase in which the pressure at the outlet of the element to be checked decreases more rapidly, and a third monotonous phase in which the pressure at the outlet of the element to be checked is equal to an inlet pressure of the storage tank.

4. The method according to claim 1, wherein the step of determining the tightness of the element to be checked determines a leakage flow rate of each phase of the trend curve using a slope associated with said phase.

5. The method according to claim 4, wherein the step of determining the tightness of the element to be checked determines a point of inflection on the trend curve referred to as the leakage pressure, marking the transition from the first decreasing phase to the second decreasing phase.

6. The method according to claim 5, comprising a step of determining the remaining service life of the seals of the element to be checked on the basis of a predefined performance indicator as a function of the distribution of the trend curve.

7. The method according to claim 1, wherein the performance indicator is chosen from: the duration of the first decreasing phase of the trend curve, the leakage flow rate associated with the first decreasing phase of the trend curve, the value of the leakage pressure marking the transition from the first decreasing phase to the second decreasing phase.

8. The method according to claim 1, further comprising generating, on the basis of a value of the performance indicator, a signal that can be used in a maintenance operation for the element to be checked.

9. The method according to claim 1, wherein the trend curve is a function of the ambient temperature and/or the temperature of a coolant fluid of the element to be checked, and/or the material of the seals of the element to be checked and/or the geometry of the seals of the element to be checked.

10. The method according to claim 1, wherein the element to be checked is a fluid machine, such as a compressor or a pump.

11. The method according to claim 10, wherein the fluid machine comprises a liner, a piston movable within the liner, the seal or seals being arranged in one or more respective grooves provided in a side wall of the piston facing a side wall of the liner.

12. The method according to claim 1, wherein the element to be checked is a valve.
